(19) United States
(12) Patent Application Publication
(10) Pub. No.: US 2025/0318520 A1
(43) Pub. Date: Oct. 16, 2025

(54) SPIROTETRAMAT COMPOSITIONS COMPRISING ADJUVANTS

(71) Applicant: ADAMA MAKHTESHIM LTD., Beer Sheva (IL)

(72) Inventors: Jacob FRIEDMAN, Beer Sheva (IL); Yogev DAHAN, Beer Sheva (IL); Noam Ben NAIM, Ashdod (IL)

(73) Assignee: ADAMA MAKHTESHIM LTD., Beer Sheva (IL)

(21) Appl. No.: 18/551,665

(22) PCT Filed: Mar. 23, 2022
(86) PCT No.: PCT/IL2022/050322

§ 371 Date: Sep. 21, 2023

Related U.S. Application Data
(60) Provisional application No. 63/165,229, filed on Mar. 24, 2021.

(51) Int. Cl. A01N 25/04; A01N 25/30; A01N 47/06; A01P 5/00; A01P 7/02; A01P 7/04; A01P 9/00

(52) U.S. Cl. CPC A01N 25/04; A01N 25/30; A01N 47/06; A01P 5/00; A01P 7/02; A01P 7/04; A01P 9/00

(57) ABSTRACT

The invention relates to a composition comprising a dispersion of solid particles of spirotetramat, an emulsification system, at least one adjuvant and an agriculturally acceptable carrier. The invention also relates to the use of an emulsification system for the addition of at least one adjuvant to a composition comprising dispersion of solid particles of spirotetramat and an agriculturally acceptable carrier. The invention describes a method for preparing a stable built-in adjuvants compatible composition characterized in the addition of emulsification system and at least one adjuvant to a dispersion of solid particles of spirotetramat in an agriculturally acceptable carrier. The compositions of the invention provide excellent control efficacy.

### RELATED APPLICATIONS

This application is a U.S. National Stage Application, filed under 35 U.S.C. § 371, of International Application No. PCT/IL2022/050322, filed Mar. 23, 2022, which claims the benefit of U.S. Provisional Patent Application No. 63/165,229, filed Mar. 24, 2021, the contents of which are incorporated herein by reference in their entirety.

### TECHNICAL FIELD OF THE INVENTION

The present invention relates to novel stable compositions comprising dispersion of solid particles of spirotetramat, an emulsification system and at least one adjuvant. The use of the emulsification system enables the addition of at least one adjuvant to the composition without damaging its stability and therefore providing excellent control efficacy.

### BACKGROUND OF THE INVENTION

Spirotetramat is a tetramic acid derivative and acts as a lipid biosynthesis inhibitor (Nauen et al., 2008), similar to the tetronic acid derivatives spirodiclofen and spiromesifen. These compounds belong to a relatively new class of insecticides, the ketoenols.

Spirotetramat is particularly effective against immature stages of sucking pests such as whiteflies, aphids, psyllids mealybugs and scales; it significantly reduces fecundity and fertility of females of these pests, and consequently reduces insect populations. Spirotetramat also has translocation properties; after foliar uptake the insecticidal activity is translocated within the entire vascular system, i.e. it moves upwards and downwards through its translocation in the xylem and phloem, respectively (Nauen et al 2008).

Spirotetramat represents a new alternative for the control of problematic insects, such as apple wholly whitefly and whitefly biotype Q, which cause severe damage in agricultural crops and have developed resistance to the commonly used pesticides used for their control (Nauen et al 2008; 61(2):245-277; Ernst Bruck et al Crop Protection, Volume 28, Issue 10, 2009, Pages 838-844).

Today, the majority of pesticide products are formulated with water. The waxy surfaces of many insects, fungi, and plants make it difficult for most water-based spray solutions to penetrate their target and therefore the desired efficacy is not achieved. One of the ways to improve the efficacy of foliar applied pesticide is by increasing the penetration of the active ingredient into plant foliage (Wang and Liu 2007). The foliar uptake of active ingredients is influenced by environmental factors such as temperature, wind and humidity (Baur 1998; Wang and Liu 2007). However, adjuvants can increase foliar penetration of active ingredients through their effect on distribution, droplet size, adhesion, wetting and uptake (Gent et al 2003).

Tank-mixed adjuvants, in the form of solids or liquids, are added directly to a formulated agricultural product, such as EC, SC, OD or WG while, the term “built-in adjuvant” refers to one or more adjuvants that have been added to a particular formulation, at the manufacturing stage of the product. The practice of built-in adjuvants simplifies the use of agrochemical products for the end-user by reducing the number of ingredients that must be individually measured and applied.

It is also known that the addition of adjuvants may frequently cause poor compatibility with their mixing partners, what can lead to rapid phase separation, sedimentation, uneven spray distribution on the crops which results in a poor disease control, a phytotoxic effect or even a build-up of resistance in the target organism.

Due to the difficulties of preparing long-term stable uniform composition containing pesticide and adjuvants there is a need in improving pesticide formulations which possesses high efficacy.

It has surprisingly been found that compositions comprising a dispersion of solid particles of spirotetramat, a unique emulsification system and adjuvants are extremely stable and exhibit high efficacy as insecticidal agents.

### SUMMARY OF THE INVENTION

The present invention therefore provides a composition comprising a dispersion of solid particles of spirotetramat, an emulsification system, at least one adjuvant and an agriculturally acceptable carrier.

In other embodiments, the present invention is directed to the use of an emulsification system for the addition of at least one adjuvant to a composition comprising dispersion of solid particles of spirotetramat and an agriculturally acceptable carrier.

In further embodiments, the present invention is directed to a method for preparing a stable built-in adjuvants compatible composition characterized in the addition of emulsification system and at least one adjuvant to a dispersion of solid particles of spirotetramat in an agriculturally acceptable carrier.

### BRIEF DESCRIPTION OF DRAWINGS

FIG. 1 shows a bar graph illustrating the performance of various compositions.

### DESCRIPTION OF SPECIFIC EMBODIMENTS OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, UK, 2003), as well as “The e-Pesticide Manual, Version 3” (British Crop Protection Council, Hampshire, UK, 2003-04), the contents of each of which are incorporated herein by reference in their entirety. As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits, spores, corms, bulbs, rhizomes, sprouts basal shoots, stolons, and buds and other parts of plants, including seedlings and young plants, which are to be transplanted after germination or after emergence from soil. The “plant” or “crop” can be plants which can be obtained by conventional breeding and optimization methods or by biotechnological and genetic engineering methods or combinations of these methods, including the transgenic plants and including the plant varieties which can or cannot be protected by plant breeders' rights.

As used herein the term “ha” refers to hectare.

As used herein, the term “adjuvant” is broadly defined as any substance that itself is not a pesticide, but which enhances or is intended to enhance the effectiveness of the pesticide with which it is used.

As used herein the term “tank-mixed adjuvant” refers to at least one adjuvant which is added directly to a previously formulated agricultural product, such as an EC, SC, OD or WG.

As used herein the term “built-in adjuvant” refers to at least one adjuvant that has been added to the formulation, at the manufacturing stage of the product.

As used herein the term “dispersion of solid particles” includes a system in which distributed solid particles of an active ingredient are dispersed in a liquid continuous phase. The continuous phase may be part of the formulated product or derived by the addition of external tank mix aids.

As used herein, the phrase “tank mix” refers to organic solvents, water and/or adjuvants that are added separately before the use and must be mixed in the sprayer tank.

As used herein, the term “agriculturally acceptable carrier” means carriers which are known and accepted in the art for the formation of compositions/formulations for agricultural or horticultural use.

As used herein the term “oil phase” refers to oils in which the solubility of spirotetramat is not more than 0.1% by weight based on the total weight of spirotetramat.

As used herein the term “soluble” refers to the ability of a liquid and/or solid adjuvant to mix with the emulsification system thus forming a single-phase solution.

The “composition” or “formulation” can be applied, for example, in a single “ready-mix” form, in a combined spray mixture composed from separate formulations of the single active ingredient components, such as a “tank-mix”.

The present invention therefore provides a composition comprising a dispersion of solid particles of spirotetramat, an emulsification system, at least one adjuvant and an agriculturally acceptable carrier.

In some embodiments, the emulsification system comprises an oil phase and an emulsifier.

In some embodiments, the emulsification system comprises an oil phase and an emulsifier wherein the solubility of the spirotetramat in the oil phase is not more than 0.1% by weight based on the total amount of the spirotetramat.

In some embodiments, the oil phase is selected from mineral oil, canola oil and any combination thereof.

In some embodiments, the amount of oil phase in the composition is of about 2% to about 5% by weight, based on the total weight of the composition. In an embodiment, the amount of oil phase in the composition is of about 2.5% to about 4.5% by weight, based on the total weight of the composition. In an embodiment, the amount of oil phase is of about 4% by weight, based on the total weight of the composition. In an embodiment, the amount of oil phase is of about 2.7% by weight, based on the total weight of the composition.

In some embodiments, the amount of mineral oil in the composition is of about 2% to about 5% by weight, based on the total weight of the composition. In an embodiment, the amount of mineral oil in the composition is of about 2.5% to about 4.5% by weight, based on the total weight of the composition. In an embodiment, the amount of mineral oil is of about 4% by weight, based on the total weight of the composition. In an embodiment, the amount of mineral oil is of about 2.7% by weight, based on the total weight of the composition.

In some embodiments, the amount of canola oil in the composition is of about 2% to about 5% by weight, based on the total weight of the composition. In an embodiment, the amount of canola oil in the composition is of about 2.5% to about 4.5% by weight, based on the total weight of the composition. In an embodiment, the amount of canola oil is of about 4% by weight, based on the total weight of the composition. In an embodiment, the amount of canola oil is of about 2.7% by weight, based on the total weight of the composition.

In some embodiments, the emulsifier is selected from dioctyl sodium sulfosuccinate, polyoxyethylene alkyl ether phosphates and any combination thereof. In a more preferred embodiment, the polyoxyethylene alkyl ether phosphates is polyethylene glycol mono-C10-14-alkyl ether phosphates. Non limiting examples of polyoxyethylene alkyl ether phosphates include Rhodafac® PA23, Multitrope™ 1214 and Ethfac 142W.

In some embodiments, the amount of the emulsifier in the composition is of about 1% to about 3% by weight, based on the total weight of the composition. In an embodiment, the amount of the emulsifier in the composition is of about 1.5% to about 2.5% by weight, based on the total weight of the composition. In an embodiment, the amount of the emulsifier in the composition is of about 1.8% by weight, based on the total weight of the composition.

In some embodiments, the amount of dioctyl sodium sulfosuccinate in the composition is of about 1% to about 3% by weight, based on the total weight of the composition. In an embodiment, the amount of dioctyl sodium sulfosuccinate in the composition is of about 1.5% to about 2.5% by weight, based on the total weight of the composition. In an embodiment, the amount of dioctyl sodium sulfosuccinate in the composition is of about 1.8% by weight, based on the total weight of the composition.

In some embodiments, the amount of polyoxyethylene alkyl ether phosphates in the composition is of about 1% to about 3% by weight, based on the total weight of the composition. In an embodiment, the amount of polyoxyethylene alkyl ether phosphates in the composition is of about 1.5% to about 2.5% by weight, based on the total weight of the composition. In an embodiment, the amount of polyoxyethylene alkyl ether phosphates in the composition is of about 1.8% by weight, based on the total weight of the composition.

In some embodiments, the amount of polyethylene glycol mono-C10-14-alkyl ether phosphate in the composition is of about 1% to about 3% by weight, based on the total weight of the composition. In an embodiment, the amount of polyethylene glycol mono-C10-14-alkyl ether phosphate in the composition is of about 1.5% to about 2.5% by weight, based on the total weight of the composition. In an embodiment, the amount of polyethylene glycol mono-C10-14-alkyl ether phosphate in the composition is of about 1.8% by weight, based on the total weight of the composition.

In some embodiments, the emulsification system comprises mineral oil and dioctyl sodium sulfosuccinate.

In some embodiments, the emulsification system comprises mineral oil and polyethylene glycol mono-C10-14-alkyl ether phosphate.

In some embodiments, the emulsification system comprises canola oil and dioctyl sodium sulfosuccinate.

In some embodiments, the emulsification system comprises canola oil and polyethylene glycol mono-C10-14-alkyl ether phosphate.

In some embodiments, the ratio between the oil phase and the emulsifier is of about 1:0.3 to about 1:1. In a preferred embodiment, the ratio between the oil phase and the emulsifier is of about 1:0.4 to about 1:0.8. In a more preferred embodiment, the ratio between the oil phase and the emulsifier is of about 1:0.5.

In some embodiments, the ratio between the mineral oil and dioctyl sodium sulfosuccinate is of about 1:0.3 to about 1:1. In a preferred embodiment, the ratio between the mineral oil and dioctyl sodium sulfosuccinate is of about 1:0.4 to about 1:0.8. In a more preferred embodiment, the ratio between the mineral oil and dioctyl sodium sulfosuccinate is of about 1:0.5.

In some embodiments, the ratio between the mineral oil and polyethylene glycol mono-C10-14-alkyl ether phosphate is of about 1:0.3 to about 1:1. In a preferred embodiment, the ratio between the mineral oil and polyethylene glycol mono-C10-14-alkyl ether phosphate is of about 1:0.4 to about 1:0.8. In a more preferred embodiment, the ratio between the mineral oil and polyethylene glycol mono-C10-14-alkyl ether phosphate is of about 1:0.5.

In some embodiments, the ratio between the canola oil and dioctyl sodium sulfosuccinate is of about 1:0.3 to about 1:1. In a preferred embodiment, the ratio between the canola oil and dioctyl sodium sulfosuccinate is of about 1:0.4 to about 1:0.8. In a more preferred embodiment, the ratio between the canola oil and dioctyl sodium sulfosuccinate is of about 1:0.5.

In some embodiments, the ratio between the canola oil and polyethylene glycol mono-C10-14-alkyl ether phosphate is of about 1:0.3 to about 1:1. In a preferred embodiment, the ratio between the canola oil and polyethylene glycol mono-C10-14-alkyl ether phosphate is of about 1:0.4 to about 1:0.8. In a more preferred embodiment, the ratio between the canola oil and polyethylene glycol mono-C10-14-alkyl ether phosphate is of about 1:0.5.

In some embodiments, the at least one adjuvant is soluble in the emulsification system.

In some embodiments, the at least one adjuvant is selected from optionally alkyl ester of fatty acids, alcohol alkoxylates and any combination thereof.

The alkyl ester of fatty acids may be derived from esterified vegetable oil, no limiting examples include esters of soybean oil, corn oil, sunflower seed oil, canola oil, safflower oil, cuphea oil, jojoba oil, coconut oil, palm kernel oil and any combination thereof.

In some embodiments, the alkyl ester of fatty acids is methyl ester of fatty acids. In an embodiment, the methyl ester of fatty acids is selected from methyl esters of soybean oil, com oil, sunflower seed oil, canola oil, safflower oil, cuphea oil, jojoba oil, coconut oil, palm kernel oil and any combination thereof.

In some embodiments, the alcohol alkoxylates are compounds having the formula:

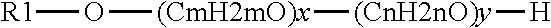

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof; m is an integer equal to 2, n is an integer equal to 3, x is an integer of from 1 to 50 and y is an integer of from 0 to 50.

In some embodiments, R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50.

In some embodiments, R1 is phenyl which is optionally mono to tri substituted by alkyl group, m is an integer equal to 2, n is an integer equal to 3, x is an integer of from 1 to 50 and y is an integer of from 0 to 50.

In some embodiments, the composition comprising a dispersion of solid particles of spirotetramat, an emulsification system comprises of an oil phase and an emulsifier, at least one adjuvant and an agriculturally acceptable carrier.

In some embodiments, the composition comprising a dispersion of solid particles of spirotetramat, an emulsification system comprises mineral oil and dioctyl sodium sulfosuccinate, at least one adjuvant and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant and an agriculturally acceptable carrier.

In some embodiments, the composition comprising a dispersion of solid particles of spirotetramat, an emulsification system comprises canola oil and dioctyl sodium sulfosuccinate, at least one adjuvant and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alkyl ester of fatty acids and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alkyl ester of fatty acids and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alkyl ester of fatty acids and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alkyl ester of fatty acids and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from methyl ester of soybean oil and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from methyl ester of soybean oil and an agriculturally acceptable carrier.

In some embodiments, the composition comprising a dispersion of solid particles of spirotetramat, an emulsification system comprises canola oil and dioctyl sodium sulfosuccinate, at least one adjuvant selected from methyl ester of soybean oil and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from methyl ester of soybean oil and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

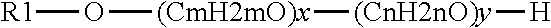

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

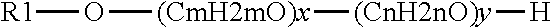

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

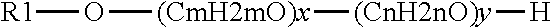

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

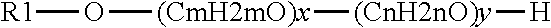

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

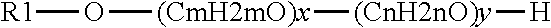

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

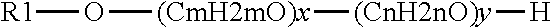

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

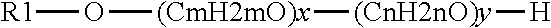

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

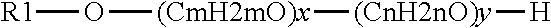

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

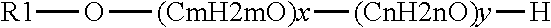

Wherein R1 is phenyl which is optionally mono to tri substituted by alkyl group, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

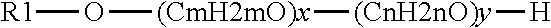

Wherein R1 is phenyl which is optionally mono to tri substituted by alkyl group, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

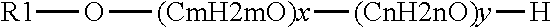

Wherein R1 is phenyl which is optionally mono to tri substituted by alkyl group, m is an integer equal to 2, n is an integer equal to 3, x is an integer of from 1 to 50 and y is an integer of from 0 to 50 and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

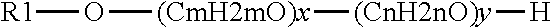

Wherein R1 is phenyl which is optionally mono to tri substituted by alkyl group, m is an integer equal to 2, n is an integer equal to 3, x is an integer of from 1 to 50 and y is an integer of from 0 to 50 and an agriculturally acceptable carrier.

In some embodiments, the amount of the at least one adjuvant in the composition is of about 1% to of about 5% by weight, based on the total weight of the composition. In an embodiment, the amount of the at least one adjuvant in the composition is of about 1.3% to of about 4.5% by weight, based on the total weight of the composition. In an embodiment, the amount of the at least one adjuvant in the composition is of about 4.4% by weight, based on the total weight of the composition. In an embodiment, the amount of the at least one adjuvant in the composition is of about 3.6% by weight, based on the total weight of the composition.

In some embodiments, the total amount of adjuvants in the composition is of about 1% to about 10% by weight, based on the total weight of the composition. In some embodiments, the total amount of adjuvants in the composition is of about 1% to about 8% by weight, based on the total weight of the composition.

In some embodiments, the total amount of adjuvants in the composition is of about 1% to about 6% by weight, based on the total weight of the composition.

In some embodiments, the at least one adjuvant in the composition selected from alkyl ester of fatty acids is at the amount of about 1% to of about 5% by weight, based on the total weight of the composition. In an embodiment, the at least one adjuvant in the composition selected from alkyl ester of fatty acids is at the amount of about 1.3% to of about 4.5% by weight, based on the total weight of the composition. In an embodiment, the at least one adjuvant in the composition selected from me ester of fatty acids is at the amount of about 4.4% by weight, based on the total weight of the composition. In an embodiment, the at least one adjuvant in the composition selected from me ester of fatty acids is at the amount of about 3.6% by weight, based on the total weight of the composition.

In some embodiments, the at least one adjuvant in the composition selected from methyl ester of fatty acids is at the amount of about 1% to of about 5% by weight, based on the total weight of the composition. In an embodiment, the at least one adjuvant in the composition selected from methyl ester of fatty acids is at the amount of about 1.3% to of about 4.5% by weight, based on the total weight of the composition. In an embodiment, the at least one adjuvant in the composition selected from methyl ester of fatty acids is at the amount of about 4.4% by weight, based on the total weight of the composition. In an embodiment, the at least one adjuvant in the composition selected from methyl ester of fatty acids is at the amount of about 3.6% by weight, based on the total weight of the composition.

In some embodiments, the at least one adjuvant in the composition is methyl ester of soybean oil at the amount of about 1% to of about 5% by weight, based on the total weight of the composition. In an embodiment, the at least one adjuvant in the composition is methyl ester of soybean oil at the amount of about 1.3% to of about 4.5% by weight, based on the total weight of the composition. In an embodiment, the at least one adjuvant in the composition is methyl ester of soybean oil at the amount of about 4.4% by weight, based on the total weight of the composition. In an embodiment, the at least one adjuvant in the composition is methyl ester of soybean oil at the amount of about 3.6% by weight, based on the total weight of the composition.

In some embodiments, the at least one adjuvant in the composition selected from alcohol alkoxylates having the formula:

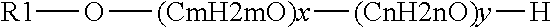

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is 10 an integer of from 0 to 50, is at the amount of about 1% to of about 5% by weight, based on the total weight of the composition.

In some embodiments, the at least one adjuvant in the composition selected from alcohol alkoxylates having the formula:

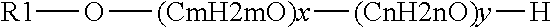

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 1.3% to of about 4.5% by weight, based on the total weight of the composition.

In some embodiments, the at least one adjuvant in the composition selected from alcohol alkoxylates having the formula:

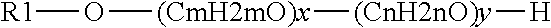

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 4.4% by weight, based on the total weight of the composition.

In some embodiments, the at least one adjuvant in the composition selected from alcohol alkoxylates having the formula:

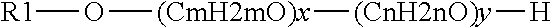

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 3.6% by weight, based on the total weight of the composition.

In some embodiments, the at least one adjuvant in the composition selected from alcohol alkoxylates having the formula:

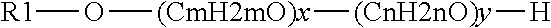

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, is at the amount of about 1% to of about 5% by weight, based on the total weight of the composition.

In some embodiments, the at least one adjuvant in the composition selected from alcohol alkoxylates having the formula:

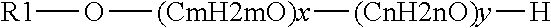

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, is at amount of about 1.3% to of about 4.5% by weight, based on the total weight of the composition.

In an embodiment, the at least one adjuvant in the composition selected from alcohol alkoxylates having the formula:

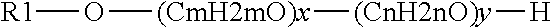

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, is at the amount of about 4.4% by weight, based on the total weight of the composition.

In an embodiment, the at least one adjuvant in the composition selected from alcohol alkoxylates having the formula:

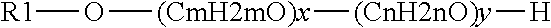

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, is at the amount of about 3.6% by weight, based on the total weight of the composition.

In some embodiments, the at least one adjuvant in the composition selected from alcohol alkoxylates having the formula:

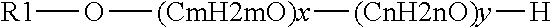

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, is at the amount of about 1% to of about 5% by weight, based on the total weight of the composition.

In some embodiments, the at least one adjuvant in the composition selected from alcohol alkoxylates having the formula:

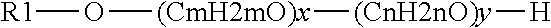

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, is at amount of about 1.3% to of about 4.5% by weight, based on the total weight of the composition.

In an embodiment, the at least one adjuvant in the composition selected from alcohol alkoxylates having the formula:

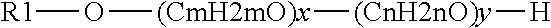

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, is at the amount of about 4.4% by weight, based on the total weight of the composition.

In an embodiment, the at least one adjuvant in the composition selected from alcohol alkoxylates having the formula:

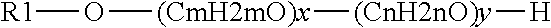

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, is at the amount of about 3.6% by weight, based on the total weight of the composition.

In some embodiments, the at least one adjuvant in the composition selected from alcohol alkoxylates having the formula:

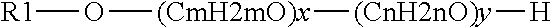

Wherein R1 is phenyl which is optionally mono to tri substituted by alkyl group, m is an integer equal to 2, n is an integer equal to 3, x is an integer of from 1 to 50 and y is an integer of from 0 to 50, is at the amount of about 1% to of about 5% by weight, based on the total weight of the composition.

In some embodiments, the at least one adjuvant in the composition selected from alcohol alkoxylates having the formula:

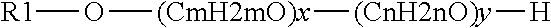

Wherein R1 is phenyl which is optionally mono to tri substituted by alkyl group, m is an integer equal to 2, n is an integer equal to 3, x is an integer of from 1 to 50 and y is an integer of from 0 to 50, is at amount of about 1.3% to of about 4.5% by weight, based on the total weight of the composition.

In an embodiment, the at least one adjuvant in the composition selected from alcohol alkoxylates having the formula:

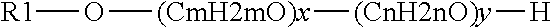

Wherein R1 is phenyl which is optionally mono to tri substituted by alkyl group, m is an x is an integer of from 1 to 50 and y is an integer of from 0 to 50, is at the amount of about 4.4% by weight, based on the total weight of the composition.

In an embodiment, the at least one adjuvant in the composition selected from alcohol alkoxylates having the formula:

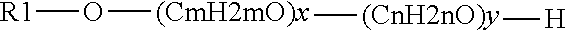

Wherein R1 is phenyl which is optionally mono to tri substituted by alkyl group, m is an integer equal to 2, n is an integer equal to 3, x is an integer of from 1 to 50 and y is an integer of from 0 to 50, is at the amount of about 3.6% by weight, based on the total weight of the composition.

In some embodiments, the composition comprising a dispersion of solid particles of spirotetramat, an emulsification system comprises mineral oil and dioctyl sodium sulfosuccinate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyoxyethylene alkyl ether phosphates, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyoxyethylene alkyl ether phosphates, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyethylene glycol mono-C10-14-alkyl ether phosphate, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyoxyethylene alkyl ether phosphates, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyoxyethylene alkyl ether phosphates, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyethylene glycol mono-C10-14-alkyl ether phosphate, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyoxyethylene alkyl ether phosphates, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyoxyethylene alkyl ether phosphates, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyoxyethylene alkyl ether phosphates, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil polyethylene glycol mono-C10-14-alkyl ether phosphate, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises canola oil and polyoxyethylene alkyl ether phosphates, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyoxyethylene alkyl ether phosphates, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyethylene glycol mono-C10-14-alkyl ether phosphate, at least one adjuvant selected from alkyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alkyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and polyoxyethylene alkyl ether phosphates, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyoxyethylene alkyl ether phosphates, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyethylene glycol mono-C10-14-alkyl ether phosphate, at least one adjuvant selected from methyl ester of fatty acids, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from methyl ester of fatty acids, in an amount of about 3.6% by weight, based on the total weight of the composition and an agriculturally acceptable carrier.

In some embodiments, the composition comprising a dispersion of solid particles of spirotetramat, an emulsification system comprises canola oil and polyoxyethylene alkyl ether phosphates, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyoxyethylene alkyl ether phosphates, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises canola oil and polyoxyethylene alkyl ether phosphates, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, the at least one adjuvant is methyl ester of soybean oil, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil polyethylene glycol mono-C10-14-alkyl ether phosphate, the at least one adjuvant is methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, the at least one adjuvant is methyl ester of soybean oil, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, the at least one adjuvant is methyl ester of soybean oil, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

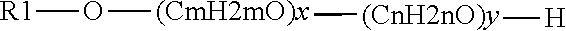

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

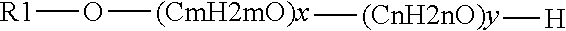

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

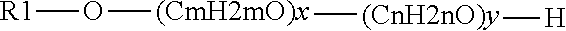

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

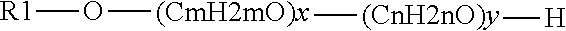

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

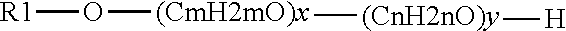

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

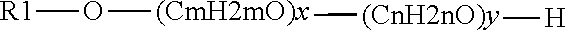

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

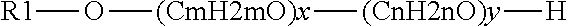

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

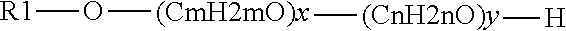

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

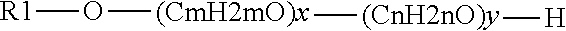

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

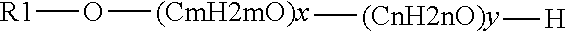

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and dioctyl sodium sulfosuccinate, at least one adjuvant selected from alcohol alkoxylates having the formula:

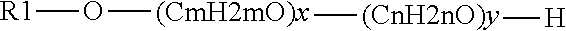

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

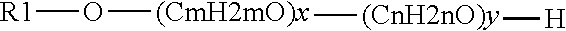

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and dioctyl sodium sulfosuccinate, at least one adjuvant selected from alcohol alkoxylates having the formula:

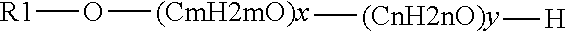

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

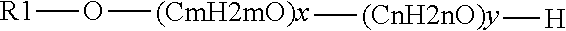

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

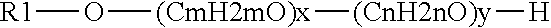

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

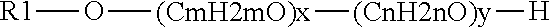

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

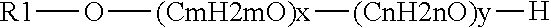

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

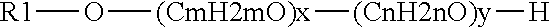

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

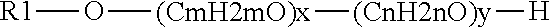

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

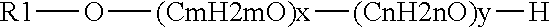

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

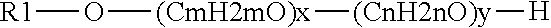

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

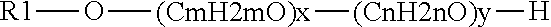

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

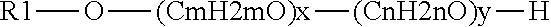

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

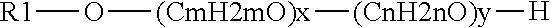

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises mineral oil and polyethylene glycol mono-C10-14-alkyl ether phosphate, at least one adjuvant selected from alcohol alkoxylates having the formula:

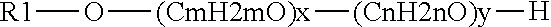

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

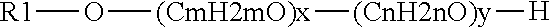

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

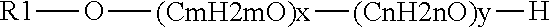

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

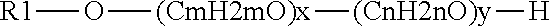

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

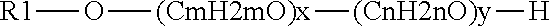

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

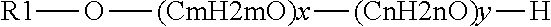

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

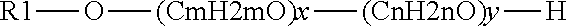

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

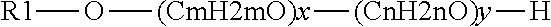

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

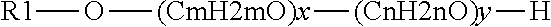

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

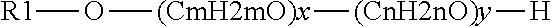

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and dioctyl sodium sulfosuccinate, at least one adjuvant selected from alcohol alkoxylates having the formula:

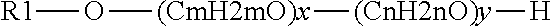

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

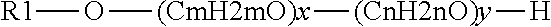

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and dioctyl sodium sulfosuccinate, at least one adjuvant selected from alcohol alkoxylates having the formula:

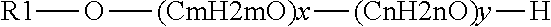

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

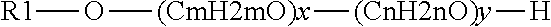

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

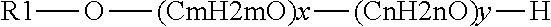

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

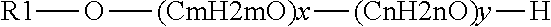

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

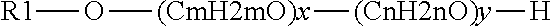

Wherein R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

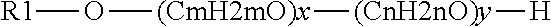

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

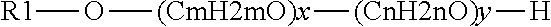

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

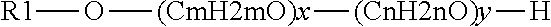

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

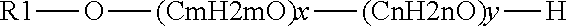

Wherein R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

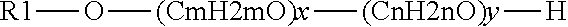

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

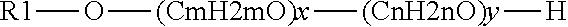

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

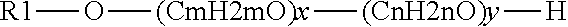

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In an embodiment, the composition comprising a dispersion of solid particles of spirotetramat, an emulsification system comprises canola oil and polyethylene glycol mono-C10-14-alkyl ether phosphate, at least one adjuvant selected from alcohol alkoxylates having the formula:

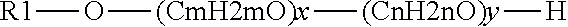

Wherein R1 is phenyl which is optionally mono to tri substituted by alkyl group, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the amount of spirotetramat is of about 10% to of about 60% by weight, based on the total weight of the composition. In an embodiment, the amount of spirotetramat is of about 15% to of about 50% by weight, based on the total weight of the composition. In an embodiment, the amount of spirotetramat is of about 44% by weight, based on the total weight of the composition.

In some embodiments, the composition comprising a dispersion of solid particles of spirotetramat in amount of about 10% to of about 60% by weight, based on the total weight of the composition, an emulsification system, at least one adjuvant and an agriculturally acceptable carrier.

In some embodiments, the composition comprising a dispersion of solid particles of spirotetramat in amount of about 10% to of about 60% by weight, based on the total weight of the composition, an emulsification system comprises an oil phase and an emulsifier, at least one adjuvant and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier, at least one adjuvant and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant which is soluble in the emulsification system and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids, alcohol alkoxylates and any combination thereof and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alcohol alkoxylates and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

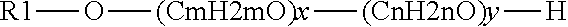

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

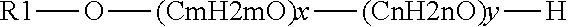

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to about 5% by weight, based on the total weight of the composition and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

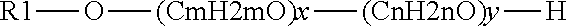

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to about 4.5% by weight, based on the total weight of the composition and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

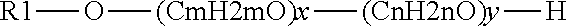

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

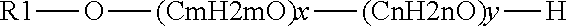

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alkyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of fatty acids, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of soybean oil, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alkyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of fatty acids, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of soybean oil, in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alkyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alkyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of fatty acids, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of fatty acids, in an amount of about 3.6% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of soybean oil, in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from methyl ester of soybean oil, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates in an amount of about 10% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and p polyethylene glycol mono-C10-14-alkyl ether phosphate, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and p polyethylene glycol mono-C10-14-alkyl ether phosphate, at least one adjuvant selected from alcohol alkoxylates in an amount of about 1.3% to of about 4.5% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates in an amount of about 4.4% by weight, based on the total weight of the composition and an agriculturally acceptable carrier.

In an embodiment, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates having the formula:

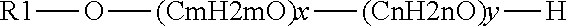

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates having the formula:

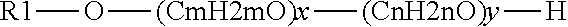

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates having the formula:

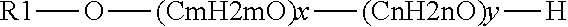

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and dioctyl sodium sulfosuccinate, at least one adjuvant selected from alcohol alkoxylates having the formula:

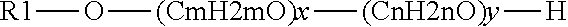

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates having the formula:

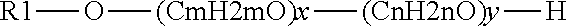

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates having the formula:

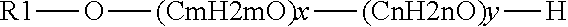

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates having the formula:

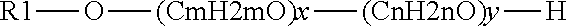

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyoxyethylene alkyl ether phosphates, at least one adjuvant selected from alcohol alkoxylates having the formula:

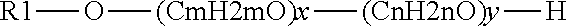

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates having the formula:

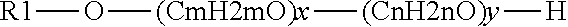

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates having the formula:

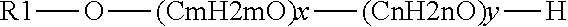

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates having the formula:

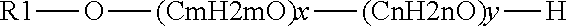

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises mineral oil and polyethylene glycol mono-C10-14-alkyl ether phosphate, at least one adjuvant selected from alcohol alkoxylates having the formula:

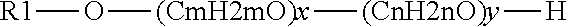

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates having the formula:

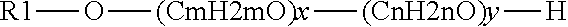

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates having the formula:

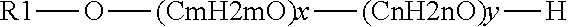

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates having the formula:

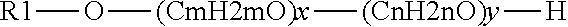

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and dioctyl sodium sulfosuccinate, at least one adjuvant selected from alcohol alkoxylates having the formula:

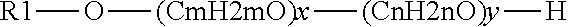

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates having the formula:

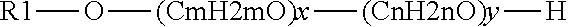

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates having the formula:

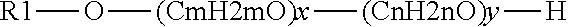

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates having the formula:

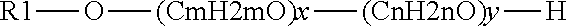

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyoxyethylene alkyl ether phosphates, at least one adjuvant selected from alcohol alkoxylates having the formula:

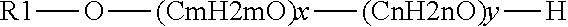

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates having the formula:

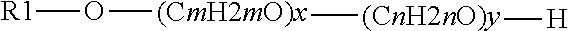

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to of about 5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and p polyethylene glycol mono-C10-14-alkyl ether phosphate, at least one adjuvant selected from alcohol alkoxylates having the formula:

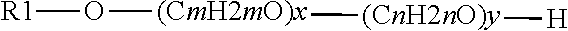

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to of about 4.5% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates having the formula:

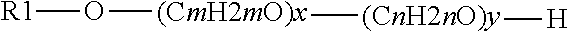

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and an agriculturally acceptable carrier.

In some embodiments, the composition comprising a dispersion of solid particles of spirotetramat in amount of about 44% by weight based on the total weight of the composition, an emulsification system comprises canola oil and polyethylene glycol mono-C10-14-alkyl ether phosphate, at least one adjuvant selected from alcohol alkoxylates having the formula:

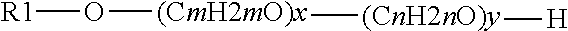

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and an agriculturally acceptable carrier.

In some embodiments, the agriculturally acceptable carrier is liquid or solid.

In some embodiments, the liquid carrier is water.

In some embodiments, the amount of the liquid carrier is of about 8% to about 36% by weight, based on the total weight of the composition.

In more specific embodiment, the amount of the liquid carrier is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the amount of water is of about 8% to about 36% by weight, based on the total weight of the composition.

In more specific embodiment, the amount of water is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the composition comprising a dispersion of solid particles of spirotetramat in amount of about 10% to of about 60% by weight, based on the total weight of the composition, an emulsification system, at least one adjuvant and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase and an emulsifier, at least one adjuvant and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier, at least one adjuvant and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant which is soluble in the emulsification system and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids, alcohol alkoxylates and any combination thereof and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and water as agriculturally acceptable carrier.

In some embodiments, the composition comprising a dispersion of solid particles of spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alcohol alkoxylates and water as agriculturally acceptable carrier.

In some embodiments, the composition comprising a dispersion of solid particles spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

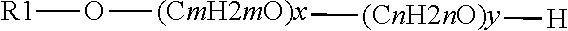

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, and water as agriculturally acceptable carrier.

In some embodiments, the composition comprising a dispersion of solid particles spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

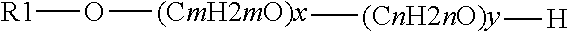

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1% to about 5% by weight, based on the total weight of the composition and water as agriculturally acceptable carrier.

In some embodiments, the composition comprising a dispersion of solid particles spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

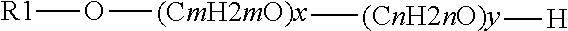

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 1.3% to about 4.5% by weight, based on the total weight of the composition and water as agriculturally acceptable carrier.

In some embodiments, the composition comprising a dispersion of solid particles spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

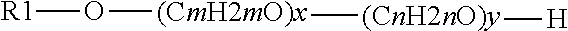

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 4.4% by weight, based on the total weight of the composition and water as agriculturally acceptable carrier.

In some embodiments, the composition comprising a dispersion of solid particles spirotetramat in amount of about 10% to of about 60% by weight, based on the total weight of the composition, an emulsification system comprises an oil phase selected from mineral oil, canola oil and any combination thereof and an emulsifier selected from dioctyl sodium sulfosuccinate, polyoxyethylene alkyl ether phosphates and any combination thereof, at least one adjuvant selected from alkyl ester of fatty acids and/or alcohol alkoxylates having the formula:

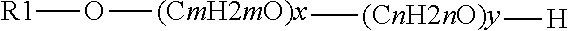

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, in an amount of about 3.6% by weight, based on the total weight of the composition and water as agriculturally acceptable carrier.

In some embodiments, the solid carrier is selected from calcium carbonate, kaolin, talc, corn starch, lactose and any combination thereof.

In some embodiments, the pH of the formulation is of about 3.6 to about 4.5.

In a preferred embodiment the pH of the formulation is of about 4 to about 4.5.

In some embodiments, the pH of the formulation is adjusted by adding a pH reagent such as an acid.

In an embodiment, the pH reagent is selected from citric acid, hydrochloric acid and any combination thereof.

The compositions according to the invention remain stable even after prolonged storage at elevated temperatures or in the cold, since no crystal growth is observed.

The present invention also provides a method for controlling and/or preventing animal pests comprising applying an effective amount of the composition to a locus where the animal pest is to be controlled and/or prevented so as to thereby control and/or prevent the animal pest.

In some embodiments, the locus where the animal pests to be controlled is a crop field. No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The compositions of the invention can be used to combat and control infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs); Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophi-lus spp., Brevipalpus spp., Bryobia praetiosa, Calipitrimerus spp., Chorioptes spp., Derma-nyssus gallinae, Eotetranychus carpini, Eriophyes spp., Hyalomma spp., Ixodes spp., Oly-gonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Lepti-notarsa decemLineata, Lissorhoptrus spp., Melolontha spp., Orycaephilus spp., Otiorhyn-chus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Lep-tocorisa spp., Nezara spp., Piesma spp., Rhodnius spp., Sahlbergella singularis, Scotino-phara spp. and Triatoma spp.; From the order Homoptera, for example Aleurothrixus floccosus, Aleyrodes brassicae, Aonidiella spp., Aphididae, Aphis spp., Aspi-diotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplo-campa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambi-guella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., HeIIuIa undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.03 L/ha to about 0.6 L/ha.

In some embodiments, the composition is applied in an amount from about 18 g/ha of spirotetramat to about 288 g/ha of spirotetramat.

In some embodiments, the compositions of the present invention disclosed herein are for the use for controlling and/or preventing animal pests.

The present invention also provides the use of an emulsification system for the addition of at least one adjuvant to a composition comprising dispersion of solid particles of spirotetramat and an agriculturally acceptable carrier.

In some embodiments, the emulsification system comprises an oil phase and an emulsifier.

In some embodiments, the emulsification system comprises an oil phase and an emulsifier wherein the solubility of the spirotetramat in the oil phase is not more than 0.1% by weight based on the total amount of the spirotetramat.

In some embodiments, the oil phase is selected from mineral oil, canola oil and any combination thereof.

In some embodiments, the amount of oil phase in the composition is of about 2% to about 5% by weight, based on the total weight of the composition. In an embodiment, the amount of oil phase in the composition is of about 2.5% to about 4.5% by weight, based on the total weight of the composition. In an embodiment, the amount of oil phase is of about 4% by weight, based on the total weight of the composition. In an embodiment, the amount of oil phase is of about 2.7% by weight, based on the total weight of the composition.

In some embodiments, the amount of mineral oil in the composition is of about 2% to about 5% by weight, based on the total weight of the composition. In an embodiment, the amount of mineral oil in the composition is of about 2.5% to about 4.5% by weight, based on the total weight of the composition. In an embodiment, the amount of mineral oil is of about 4% by weight, based on the total weight of the composition. In an embodiment, the amount of mineral oil is of about 2.7% by weight, based on the total weight of the composition.

In some embodiments, the amount of canola oil in the composition is of about 2% to about 5% by weight, based on the total weight of the composition. In an embodiment, the amount of canola oil in the composition is of about 2.5% to about 4.5% by weight, based on the total weight of the composition. In an embodiment, the amount of canola oil is of about 4% by weight, based on the total weight of the composition. In an embodiment, the amount of canola oil is of about 2.7% by weight, based on the total weight of the composition.

In some embodiments, the emulsifier is selected from dioctyl sodium sulfosuccinate, polyoxyethylene alkyl ether phosphates and any combination thereof.

In some embodiments, the amount of the emulsifier in the composition is of about 1% to about 3% by weight, based on the total weight of the composition. In an embodiment, the amount of the emulsifier in the composition is of about 1.5% to about 2.5% by weight, based on the total weight of the composition. In an embodiment, the amount of the emulsifier in the composition is of about 1.8% by weight, based on the total weight of the composition.

In some embodiments, the amount of dioctyl sodium sulfosuccinate in the composition is of about 1% to about 3% by weight, based on the total weight of the composition. In an embodiment, the amount of dioctyl sodium sulfosuccinate in the composition is of about 1.5% to about 2.5% by weight, based on the total weight of the composition. In an embodiment, the amount of dioctyl sodium sulfosuccinate in the composition is of about 1.8% by weight, based on the total weight of the composition.

In some embodiments, the amount of polyoxyethylene alkyl ether phosphates in the composition is of about 1% to about 3% by weight, based on the total weight of the composition. In an embodiment, the amount of polyoxyethylene alkyl ether phosphates in the composition is of about 1.5% to about 2.5% by weight, based on the total weight of the composition. In an embodiment, the amount of polyoxyethylene alkyl ether phosphates in the composition is of about 1.8% by weight, based on the total weight of the composition.

In some embodiments, the amount of polyethylene glycol mono-C10-14-alkyl ether phosphate in the composition is of about 1% to about 3% by weight, based on the total weight of the composition. In an embodiment, the amount of polyethylene glycol mono-C10-14-alkyl ether phosphate in the composition is of about 1.5% to about 2.5% by weight, based on the total weight of the composition. In an embodiment, the amount of polyethylene glycol mono-C10-14-alkyl ether phosphate in the composition is of about 1.8% by weight, based on the total weight of the composition.

In some embodiments, the emulsification system comprises mineral oil and dioctyl sodium sulfosuccinate.

In some embodiments, the emulsification system comprises mineral oil and polyethylene glycol mono-C10-14-alkyl ether phosphate.

In some embodiments, the emulsification system comprises canola oil and dioctyl sodium sulfosuccinate.

In some embodiments, the emulsification system comprises canola oil and polyethylene glycol mono-C10-14-alkyl ether phosphate.
In some embodiments, the ratio between the oil phase and the emulsifier is of about 1:0.3 to 1:1. In a preferred embodiment, the ratio between the oil phase and the emulsifier is of about 1:0.4 to about 1:0.8. In a more preferred embodiment, the ratio between the oil phase and the emulsifier is of about 1:0.5.

In some embodiments, the ratio between the mineral oil and dioctyl sodium sulfosuccinate is of about 1:0.3 to about 1:1. In a preferred embodiment, the ratio between the mineral oil and dioctyl sodium sulfosuccinate is of about 1:0.4 to about 1:0.8. In a more preferred embodiment, the ratio between the mineral oil and dioctyl sodium sulfosuccinate is of about 1:0.5.

In some embodiments, the ratio between the mineral oil and polyethylene glycol mono-C10-14-alkyl ether phosphate is of about 1:0.3 to about 1:1. In a preferred embodiment, the ratio between the mineral oil and polyethylene glycol mono-C10-14-alkyl ether phosphate is of about 1:0.4 to about 1:0.8. In a more preferred embodiment, the ratio between the mineral oil and polyethylene glycol mono-C10-14-alkyl ether phosphate is of about 1:0.5.

In some embodiments, the ratio between the canola oil and dioctyl sodium sulfosuccinate is of about 1:0.3 to about 1:1. In a preferred embodiment, the ratio between the canola oil and dioctyl sodium sulfosuccinate is of about 1:0.4 to about 1:0.8. In a more preferred embodiment, the ratio between the canola oil and dioctyl sodium sulfosuccinate is of about 1:0.5.

In some embodiments, the ratio between the canola oil and polyethylene glycol mono-C10-14-alkyl ether phosphate is of about 1:0.3 to about 1:1. In a preferred embodiment, the ratio between the canola oil and polyethylene glycol mono-C10-14-alkyl ether phosphate is of about 1:0.4 to about 1:0.8. In a more preferred embodiment, the ratio between the canola oil and polyethylene glycol mono-C10-14-alkyl ether phosphate is of about 1:0.5.

In some embodiments, the adjuvant is soluble in the emulsification system.

In some embodiments, the adjuvant is selected from optionally alkyl ester of fatty acids, alcohol alkoxylates and any combination thereof.

The alkyl ester of fatty acids may be derived from esterified vegetable oil, no limiting examples include esters of soybean oil, corn oil, sunflower seed oil, canola oil, safflower oil, cuphea oil, jojoba oil, coconut oil, palm kernel oil and any combination thereof.

In some embodiments, the alkyl ester of fatty acids is methyl ester of fatty acids. In a preferred embodiment, the methyl ester of fatty acids is selected from methyl esters of soybean oil, com oil, sunflower seed oil, canola oil, safflower oil, cuphea oil, jojoba oil, coconut oil, palm kernel oil and any combination thereof.

In some embodiments, the adjuvant is a compound having the formula:

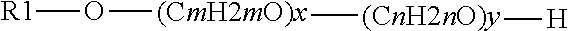

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; and any combination thereof, m is an integer equal to 2, n is an integer equal to 3, x is an integer of from 1 to 50 and y is an integer of from 0 to 50.

In some embodiments, R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50.

In some embodiments, R1 is phenyl which is optionally mono to tri substituted by alkyl group, m is an integer equal to 2, n is an integer equal to 3, x is an integer of from 1 to 50 and y is an integer of from 0 to 50.

In some embodiments, the amount of the at least one adjuvant in the composition is of about 1% to of about 5% by weight, based on the total weight of the composition. In an embodiment, the amount of the at least one adjuvant in the composition is of about 1.3% to of about 4.5% by weight, based on the total weight of the composition. In an embodiment, the amount of the at least one adjuvant in the composition is of about 4.4% by weight, based on the total weight of the composition. In an embodiment, the amount of the at least one adjuvant in the composition is of about 3.6% by weight, based on the total weight of the composition.

In some embodiments, the at least one adjuvant in the composition selected from alkyl ester of fatty acids is at the amount of about 1% to of about 5% by weight, based on the total weight of the composition. an embodiment, the at least one adjuvant in the composition selected from alkyl ester of fatty acids is at the amount of about 1.3% to of about 4.5% by weight, based on the total weight of the composition. In an embodiment, the at least one adjuvant in the composition selected from me ester of fatty acids is at the amount of about 4.4% by weight, based on the total weight of the composition. In an embodiment, the at least one adjuvant in the composition selected from me ester of fatty acids is at the amount of about 3.6% by weight, based on the total weight of the composition.

In some embodiments, the at least one adjuvant in the composition selected from methyl ester of fatty acids is at the amount of about 1% to of about 5% by weight, based on the total weight of the composition. In an embodiment, the at least one adjuvant in the composition selected from methyl ester of fatty acids is at the amount of about 1.3% to of about 4.5% by weight, based on the total weight of the composition. In an embodiment, the at least one adjuvant in the composition selected from methyl ester of fatty acids is at the amount of about 4.4% by weight, based on the total weight of the composition. In an embodiment, the at least one adjuvant in the composition selected from methyl ester of fatty acids is at the amount of about 3.6% by weight, based on the total weight of the composition.

In some embodiments, the at least one adjuvant in the composition is methyl ester of soybean oil at the amount of about 1% to of about 5% by weight, based on the total weight of the composition.

In an embodiment, the at least one adjuvant in the composition is methyl ester of soybean oil at the amount of about 1.3% to of about 4.5% by weight, based on the total weight of the composition. In an embodiment, the at least one adjuvant in the composition is methyl ester of soybean oil at the amount of about 4.4% by weight, based on the total weight of the composition. In an embodiment, the at least one adjuvant in the composition is methyl ester of soybean oil at the amount of about 3.6% by weight, based on the total weight of the composition.

In some embodiments, the at least one adjuvant in the composition selected from alcohol alkoxylates having the formula:

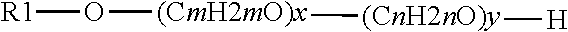

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 1% to of about 5% by weight, based on the total weight of the composition.

In some embodiments, the at least one adjuvant in the composition selected from alcohol alkoxylates having the formula:

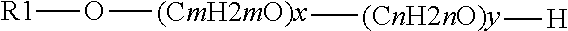

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 1.3% to of about 4.5% by weight, based on the total weight of the composition.

In some embodiments, the at least one adjuvant in the composition selected from alcohol alkoxylates having the formula:

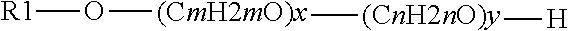

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 4.4% by weight, based on the total weight of the composition.

In some embodiments, the at least one adjuvant in the composition selected from alcohol alkoxylates having the formula:

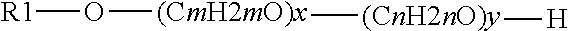

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50, is at the amount of about 3.6% by weight, based on the total weight of the composition.

In some embodiments, the amount of spirotetramat is of about 10% to of about 60% by weight, based on the total weight of the composition. In preferred embodiments, the amount of spirotetramat is of about 15% to of about 50% by weight, based on the total weight of the composition. In an embodiment, the amount of spirotetramat is of about 44% by weight, based on the total weight of the composition.

In some embodiments, the agriculturally acceptable carrier is liquid or solid.

In some embodiments, the liquid carrier is water.

In some embodiments, the amount of the liquid carrier is of about 8% to about 36% by weight, based on the total weight of the composition.

In more specific embodiment, the amount of the liquid carrier is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the amount of water is of about 8% to about 36% by weight, based on the total weight of the composition.

In more specific embodiment, the amount of water is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the solid carrier is selected from calcium carbonate, kaolin, talc, corn starch lactose and any combination thereof.

In some embodiments, the pH of the formulation is of about 3.6 to about 4.5.

In a preferred embodiment the pH of the formulation is of about 4 to about 4.5.

In some embodiments, the pH of the formulation is adjusted by adding a pH reagent such as an acid.

In an embodiment, the pH reagent is selected from citric acid, hydrochloric acid and any combination thereof.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The compositions of the invention can be used to combat and control infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs); Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophi-lus spp., Brevipalpus spp., Bryobia praetiosa, Calipitrimerus spp., Chorioptes spp., Derma-nyssus gallinae, Eotetranychus carpini, Eriophyes spp., Hyalomma spp., Ixodes spp., Oly-gonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Lepti-notarsa decemLineata, Lissorhoptrus spp., Melolontha spp., Orycaephilus spp., Otiorhyn-chus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Lep-tocorisa spp., Nezara spp., Piesma spp., Rhodnius spp., Sahlbergella singularis, Scotino-phara spp. and Triatoma spp.; From the order Homoptera, for example Aleurothrixus floccosus, Aleyrodes brassicae, Aonidiella spp., Aphididae, Aphis spp., Aspi-diotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplo-campa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambi-guella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., HeIIuIa undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.03 L/ha to about 0.6 L/ha.

In some embodiments, the composition is applied in an amount from about 18 g/ha of spirotetramat to about 288 g/ha of spirotetramat.

The present invention also provides a method for preparing a stable built-in adjuvant compatible composition characterized in the addition of emulsification system and at least one adjuvant to a dispersion of solid particles of spirotetramat in an agriculturally acceptable carrier.

In some embodiments, the emulsification system comprises an oil phase and an emulsifier.

In some embodiments, the emulsification system comprises an oil phase and an emulsifier wherein the solubility of the spirotetramat in the oil phase is not more than 0.1% by weight based on the total amount of the spirotetramat.

In some embodiments, the oil phase is selected from mineral oil, canola oil and any combination thereof.

In some embodiments, the amount of oil phase in the composition is of about 2% to about 5% by weight, based on the total weight of the composition. In an embodiment, the amount of oil phase in the composition is of about 2.5% to about 4.5% by weight, based on the total weight of the composition. In an embodiment, the amount of oil phase is of about 4% by weight, based on the total weight of the composition. In an embodiment, the amount of oil phase is of about 2.7% by weight, based on the total weight of the composition.

In some embodiments, the amount of mineral oil in the composition is of about 2% to about 5% by weight, based on the total weight of the composition. In an embodiment, the amount of mineral oil in the composition is of about 2.5% to about 4.5% by weight, based on the total weight of the composition. In an embodiment, the amount of mineral oil is of about 4% by weight, based on the total weight of the composition. In an embodiment, the amount of mineral oil is of about 2.7% by weight, based on the total weight of the composition.

In some embodiments, the amount of canola oil in the composition is of about 2% to about 5% by weight, based on the total weight of the composition. In an embodiment, the amount of canola oil in the composition is of about 2.5% to about 4.5% by weight, based on the total weight of the composition. In an embodiment, the amount of canola oil is of about 4% by weight, based on the total weight of the composition. In an embodiment, the amount of canola oil is of about 2.7% by weight, based on the total weight of the composition.

In some embodiments, the emulsifier is selected from dioctyl sodium sulfosuccinate, polyoxyethylene alkyl ether phosphates and any combination thereof.

In some embodiments, the emulsifier is selected from dioctyl sodium sulfosuccinate, polyoxyethylene alkyl ether phosphates and any combination thereof. In a more preferred embodiment, the polyoxyethylene alkyl ether phosphates is polyethylene glycol mono-C10-14-alkyl ether phosphates. Non limiting examples of polyoxyethylene alkyl ether phosphates include Rhodafac® PA23, Multitrope™ 1214 and Ethfac 142W.

In some embodiments, the amount of the emulsifier in the composition is of about 1% to about 3% by weight, based on the total weight of the composition. In an embodiment, the amount of the emulsifier in the composition is of about 1.5% to about 2.5% by weight, based on the total weight of the composition. In an embodiment, the amount of the emulsifier in the composition is of about 1.8% by weight, based on the total weight of the composition.

In some embodiments, the amount of dioctyl sodium sulfosuccinate in the composition is of about 1% to about 3% by weight, based on the total weight of the composition. In an embodiment, the amount of dioctyl sodium sulfosuccinate in the composition is of about 1.5% to about 2.5% by weight, based on the total weight of the composition. In an embodiment, the amount of dioctyl sodium sulfosuccinate in the composition is of about 1.8% by weight, based on the total weight of the composition.

In some embodiments, the amount of polyoxyethylene alkyl ether phosphates in the composition is of about 1% to about 3% by weight, based on the total weight of the composition. In an embodiment, the amount of polyoxyethylene alkyl ether phosphates in the composition is of about 1.5% to about 2.5% by weight, based on the total weight of the composition. In an embodiment, the amount of polyoxyethylene alkyl ether phosphates in the composition is of about 1.8% by weight, based on the total weight of the composition.

In some embodiments, the amount of polyethylene glycol mono-C10-14-alkyl ether phosphate in the composition is of about 1% to about 3% by weight, based on the total weight of the composition. In an embodiment, the amount of polyethylene glycol mono-C10-14-alkyl ether phosphate in the composition is of about 1.5% to about 2.5% by weight, based on the total weight of the composition. In an embodiment, the amount of polyethylene glycol mono-C10-14-alkyl ether phosphate in the composition is of about 1.8% by weight, based on the total weight of the composition.

In some embodiments, the emulsification system comprises mineral oil and dioctyl sodium sulfosuccinate.

In some embodiments, the emulsification system comprises mineral oil and polyethylene glycol mono-C10-14-alkyl ether phosphate.

In some embodiments, the emulsification system comprises canola oil and dioctyl sodium sulfosuccinate.

In some embodiments, the emulsification system comprises canola oil and polyethylene glycol mono-C10-14-alkyl ether phosphate.

In some embodiments, the ratio between the oil phase and the emulsifier is of about 1:0.3 to about 1:1. In a preferred embodiment, the ratio between the oil phase and the emulsifier is of about 1:0.4 to about 1:0.8. In a more preferred embodiment, the ratio between the oil phase and the emulsifier is of about 1:0.5.

In some embodiments, the ratio between the mineral oil and dioctyl sodium sulfosuccinate is of about 1:0.3 to about 1:1. In a preferred embodiment, the ratio between the mineral oil and dioctyl sodium sulfosuccinate is of about 1:0.4 to about 1:0.8. In a more preferred embodiment, the ratio between the mineral oil and dioctyl sodium sulfosuccinate is of about 1:0.5.

In some embodiments, the ratio between the mineral oil and polyethylene glycol mono-C10-14-alkyl ether phosphate is of about 1:0.3 to about 1:1. In a preferred embodiment, the ratio between the mineral oil and polyethylene glycol mono-C10-14-alkyl ether phosphate is of about 1:0.4 to about 1:0.8. In a more preferred embodiment, the ratio between the mineral oil and polyethylene glycol mono-C10-14-alkyl ether phosphate is of about 1:0.5.

In some embodiments, the ratio between the canola oil and dioctyl sodium sulfosuccinate is of about 1:0.3 to about 1:1. In a preferred embodiment, the ratio between the canola oil and dioctyl sodium sulfosuccinate is of about 1:0.4 to about 1:0.8. In a more preferred embodiment, the ratio between the canola oil and dioctyl sodium sulfosuccinate is of about 1:0.5.

In some embodiments, the ratio between the canola oil and polyethylene glycol mono-C10-14-alkyl ether phosphate is of about 1:0.3 to about 1:1. In a preferred embodiment, the ratio between the canola oil and polyethylene glycol mono-C10-14-alkyl ether phosphate is of about 1:0.4 to about 1:0.8. In a more preferred embodiment, the ratio between the canola oil and polyethylene glycol mono-C10-14-alkyl ether phosphate is of about 1:0.5.

In some embodiments, the adjuvant is soluble in the emulsification system.

In some embodiments, the adjuvant is selected from optionally alkyl ester of fatty acids, alcohol alkoxylates and any combination thereof.
The alkyl ester of fatty acids may be derived from esterified vegetable oil, no limiting examples include esters of soybean oil, corn oil, sunflower seed oil, canola oil, safflower oil, cuphea oil, jojoba oil, coconut oil, palm kernel oil and any combination thereof.

In some embodiments, the alkyl ester of fatty acids is methyl ester of fatty acids. In a preferred embodiment, the methyl ester of fatty acids is selected from methyl esters of soybean oil, com oil, sunflower seed oil, canola oil, safflower oil, cuphea oil, jojoba oil, coconut oil, palm kernel oil and any combination thereof.

In some embodiments, the alcohol alkoxylates are compounds having the formula:

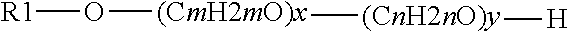

wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50.

In some embodiments, R1 is linear or branched, saturated or unsaturated alkyl radical having from 7 to 20 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having from 14 to 20 carbon atoms, m is an integer equal to 2, n is an integer equal to 3, x is an integer of from 1 to 50 and y is an integer of from 0 to 50.

In some embodiments, R1 is phenyl which is optionally mono to tri substituted by alkyl group, m is an integer equal to 2, n is an integer equal to 3, x is an integer of from 1 to 50 and y is an integer of from 0 to 50.

In some embodiments, the amount of the at least one adjuvant in the composition is of about 1% to of about 5% by weight, based on the total weight of the composition. In an embodiment, the amount of the at least one adjuvant in the composition is of about 1.3% to of about 4.5% by weight, based on the total weight of the composition. In an embodiment, the amount of the at least one adjuvant in the composition is of about 4.4% by weight, based on the total weight of the composition. In an embodiment, the amount of the at least one adjuvant in the composition is of about 3.6% by weight, based on the total weight of the composition.

In some embodiments, the amount of spirotetramat is of about 10% to of about 60% by weight, based on the total weight of the composition. In some preferred embodiments, the amount of spirotetramat is of about 15% to of about 50% by weight, based on the total weight of the composition. In an embodiment, the amount of spirotetramat is of about 44% by weight, based on the total weight of the composition.

In some embodiments, the agriculturally acceptable carrier is liquid or solid.

In some embodiments, the liquid carrier is water.

In some embodiments, the amount of the liquid carrier is of about 8% to about 36% by weight, based on the total weight of the composition.

In more specific embodiment, the amount of the liquid carrier is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the amount of water is of about 8% to about 36% by weight, based on the total weight of the composition.

In more specific embodiment, the amount of water is of about 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% or 36% by weight, based on the total weight of the composition.

In some embodiments, the solid carrier is selected from calcium carbonate, kaolin, talc, corn starch lactose and any combination thereof.

In some embodiments, the pH of the formulation is of about 3.6 to about 4.5.

In a preferred embodiment the pH of the formulation is of about 4 to about 4.5.

In some embodiments, the pH of the formulation is adjusted by adding a pH reagent such as an acid.

In an embodiment, the pH reagent is selected from citric acid, hydrochloric acid and any combination thereof.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The compositions of the invention can be used to combat and control infestations of animal pests such as Lepidoptera, Diptera, Herniptera, Thysanoptera, Coleoptera, Hymenoptera and also other invertebrate pests, for example, acarine, nemraode and rnollusc pests. Insects, acarinles, nematodes and molluscs are hereinafter collectively referred to as pests. The aninal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species wvhich may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs)-Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophi-lus spp., Brevipalpus spp., Bryobia praetiosa, Calipitrimerus spp., Chorioptes spp., Derma-nyssus gallinae, Eotetranychus carpini, Eriophyes spp., Hyalomma spp., Ixodes spp., Oly-gonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Lepti-notarsa decemLineata, Lissorhoptrus spp., Melolontha spp., Orycaephilus spp., Otiorhyn-chus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example Cimex spp., Distantiella theobroma, Dysdercus spp., Euchistus spp., Eurygaster spp., Lep-tocorisa spp., Nezara spp., Piesma spp., Rhodnius spp., Sahlbergella singularis, Scotino-phara spp. and Triatoma spp.; From the order Homoptera, for example Aleurothrixus floccosus, Aleyrodes brassicae, Aonidiella spp., Aphididae, Aphis spp., Aspi-diotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium comi, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplo-campa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambi-guella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., HeIIuIa undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.03 L/ha to about 0.6 L/ha.

In some embodiments, the composition is applied in an amount from about 18 g/ha of spirotetramat to about 288 g/ha of spirotetramat.

All the compositions and/or combinations of the invention may comprise further one or more active fungicidal, insecticidal, bactericidal or herbicidal ingredients.

Preferred fungicidal components are, for example, aldimorph, ampropylfos, ampropylfos-potassium, andoprim, anilazine, azaconazole, azoxystrobin, benalaxyl, benodanil, benomyl, benzamacril, benzamacryl-isobutyl, bialaphos, binapacryl, biphenyl, bitertanol, blasticidin-S, bromuconazole, bupirimate, buthiobate, calcium polysulphide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, debacarb, dichlorophen, diclobutrazole, diclofluanid, diclomezine, dicloran, diethofencarb, difenoconazole, dim ethirimol, dimethomorph, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromide, fluquinconazole, flurprimidol, flusilazole, flusulphamide, flutolanil, flutriafol, folpet, fosetyl-aluminium, fosetyl-sodium, fthalide, fuberidazole, furalaxyl, furamnetpyr, furcarbonil, furconazole, furconazole-cis, furmecyclox, guazatine, hexachlorobenzene, hexaconazole, hymexazole, imazalil, imibenconazole, iminoctadine, iminoctadine albesilate, iminoctadine triacetate, iodocarb, ipconazole, iprobenfos (IBP), iprodione, irumamycin, isoprothiolane, isovaledione, kasugamycin, kresoxim-methyl, copper preparations, such as: copper hydroxide, copper naphthenate, copper oxychloride, copper sulphate, copper oxide, oxine-copper and Bordeaux mixture, mancopper, mancozeb, maneb, meferimzone, mepanipyrim, mepronil, metalaxyl, metconazole, methasulphocarb, methfuroxam, metiram, metomeclam, metsulphovax, mildiomycin, myclobutanil, myclozolin, nickel dimethyldithiocarbamate, nitrothal-isopropyl, nuarimol, ofurace, oxadixyl, oxamocarb, oxolinic acid, oxycarboxim, oxyfenthiin, paclobutrazole, pefurazoate, penconazole, pencycuron, phosdiphen, picoxystrobin, pimaricin, piperalin, polyoxin, polyoxorim, probenazole, prochloraz, procymidone, propamocarb, propanosine-sodium, propiconazole, propineb, pyraclostrobin, pyrazophos, pyrifenox, pyrimethanil, pyroquilon, pyroxyfur, quinconazole, quintozene (PCNB), sulphur and sulphur preparations, tebuconazole, tecloftalam, tecnazene, tetcyclasis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, trifloxystrobin, triflumizole, triforine, triticonazole, uniconazole, validamycin A, vinclozolin, viniconazole, zarilamide, zineb and ziram.

Preferred bactericidal components are, for example, bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations. Preferred insecticidal components are, for example, abamectin, acephate, acetamiprid, acrinathrin, alanycarb, aldicarb, aldoxycarb, alpha-cypermethrin, alphamethrin, amitraz, avermectin, azadirachtin, azamethiphos, azinphos A, azinphos M, azocyclotin, benidiocarb, benfuracarb, bensultap, benzoximate, betacyfluthrin, bifenazate, bifenthrin, bioethanomethrin, biopermethrin, bistrifluron, BPMC, bromophos A, bufencarb, buprofezin, butathiofos, butocarboxim, butylpyridaben, cadusafos, carbaryl, carbofuran, carbophenothion, carbosulphan, cartap, chloethocarb, chlorethoxyfos, chlorfenapyr, chlorfenvinphos, chlorfluazuron, chlormephos, chlorpyrifos, chlorpyrifos M, chlovaporthrin, chromafenozide, cisresmethrin, cispermethrin, clocythrin, cloethocarb, clofentezine, clothianidine, cyanophos, cycloprene, cycloprothrin, cyfluthrin, cyhalothrin, cyhexatin, cypermethrin, cyromazine, deltamethrin, demeton M, demeton S, demeton-S-methyl, diafenthiuron, diazinon, dichlorvos, dicofol, diflubenzuron, dimethoate, dimnethylvinphos, diofenolan, disulphoton, docusat-sodium, dofenapyn, eflusilanate, emamectin, empenthrin, endosulphan, Entomopfthora spp., esfenvalerate, ethiofencarb, ethion, ethoprophos, etofenprox, etoxazole, etrimfos, fenamiphos, fenazaquin, fenbutatin oxide, fenitrothion, fenothiocarb, fenoxacrim, fenoxycarb, fenpropathrin, fenpyrad, fenpyrithrin, fenpyroximate, fenvalerate, fipronil, fluazinam, fluazuron, flubrocythrinate, flucycloxuron, flucythrinate, flufenoxuron, flumethrin, flutenzine, fluvalinate, fonophos, fosmethilan, fosthiazate, fubfenprox, furathiocarb, hexaflumuron, hexythiazox, hydroprene, imidacloprid, indoxacarb, isazofos, isofenphos, isoxathion, lambda-cyhalothrin, lufenuron, malathion, mecarbam, metaldehyde, methamidophos, methidathion, methiocarb, methoprene, methomyl, methoxyfenozide, metolcarb, metoxadiazone, mevinphos, milbemectin, milbemycin, monocrotophos, nitenpyram, nithiazine, novaluron, omethoate, oxamyl, oxydemethon M, parathion A, parathion M, permethrin, phenthoate, phorate, phosalone, phosmet, phosphamidon, phoxim, pirimicarb, pirimiphos A, pirimiphos M, profenofos, promecarb, propargite, propoxur, prothiofos, prothoate, pymetrozine, pyraclofos, pyresmethrin, pyrethrum, pyridaben, pyridathion, pyrimidifen, pyriproxyfen, quina lphos, ribavirin, salithion, sebufos, silafluofen, spinosad, spirodiclofen, sulphotep, sulprofos, tau-fluvalinate, tebufenozide, tebufenpyrad, tebupirimiphos, teflubenzuron, tefluthrin, temephos, temivinphos, terbufos, tetrachlorvinphos, tetradifon, theta-cypermethrin, thiacloprid, thiamethoxam, thiapronil, thiatriphos, thiocyclam hydrogen oxalate, thiodicarb, thiofanox, thuringiensin, tralocythrin, tralomethrin, triarathene, triazamate, triazophos, triazuron, trichlophenidine, trichlorfon, triflumuron, trimethacarb, vamidothion, vaniliprole, zeta-cypermethrin and zolaprofos.

All the compositions and/or combinations of the invention may comprise further additives such as emulsifiers, penetrants, wetting agents, spreading agents and/or retention agents. Suitable substances are all of those which can typically be used for this purpose in agrochemicals. Suitable additives are, for example, organomodified polysiloxanes, e.g. BreakThru® OE444, BreakThru® S240, Silwett® L77, Silwett® 408; and ethoxy (5) tridecyl mono/di phosphate, e.g. Crodafos™ T5A;

Additional suitable additives which may be present in all the compositions of the invention are antifoams, adjuvants, preservatives, antioxidants, dyes and inert fillers.

Suitable antifoams are all substances which can typically be used for this purpose in agrochemicals. Preference is given to silicone oils, silicone oil formulations, magnesium stearate, phosphinic acids and phosphonic acids. Examples are BreakThru® AF9902 or BreakThru® AF9902 from Evonik Industries AG, Silcolapse® 482 from Bluestar Silicones, Silfoam® SCI 132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Suitable antioxidants are all substances which can typically be used for this purpose in agrochemicals. Preference is given to butylhydroxytoluene [3,5-di-tert-butyl-4-hydroxytoluene, CAS No. 128-37-0].

Possible dyes are all substances which can typically be used for this purpose in agrochemicals. Examples include titanium dioxide, carbon black, zinc oxide, blue pigments, red pigments and Permanent Red FGR.

The invention is illustrated by the following examples without limiting it thereby.

### EXAMPLES

### Example 1—Spirotetramat Formulation A

TABLE 1

| Materials | g/L |
|---|---|
| Spirotetramat | 480 |
| ATLOX 4913 | 30 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.10 |
| Silcolapse 432 (non-ionic, polydimethylsiloxanic | 5 |
| oil based, aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Genapol X50 (Iso-tridecyl alcohol polyglycol ether | 40 |
| with 5 EO) | |
| Xanthan Gum | 2 |
| water | Up to 1000 L |

### Preparation Procedure:

All the stages take place at room temperature about 23° C.±2° C.

Stage 1—
1. Spirotetramat, ATLOX 4913, Break Thru 233, EthylanNS 500 LQ, proxel GXL, Silcolapse 432 (half the amount), propylene glycol and water (100 g/L) were mixed.
2. The mixture was milled to get the desired particle size distribution LT 6 microns

### Stage 2—

1. ISOPAR v, EMCOL 4500 and Genapol X50 were mixed until clear solution was obtained.
2. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 2—Spirotetramat Formulation B

TABLE 2

| Materials | g/L |
|---|---|
| Spirotetramat | 480 |
| ATLOX 4913 (Acrylic copolymer solution) | 30 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.10 |
| Silcolapse 432 (non-ionic, polydimethylsiloxanic | 5 |
| oil based, aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Alkamuls AP (PEG Ester/Ethoxylated Acid) | 40 |
| Xanthan Gum | 2 |
| water | Up to 1000 L |

### Preparation Procedure:

All the stages take place at room temperature about 23° C.±2° C.

### Stage 1—

3. Spirotetramat, ATLOX 4913, Break Thru 233, EthylanNS 500 LQ, proxel GXL, Silcolapse 432 (half the amount), propylene glycol and water (100 g/L) were mixed.
4. The mixture was milled to get the desired particle size distribution LT 6 microns Stage 2—
3. ISOPAR v, EMCOL 4500 and Alkamuls AP were mixed until clear solution was obtained.
4. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 3—Spirotetramat Formulation C

TABLE 3

| Materials | g/L |
|---|---|
| Spirotetramat | 480 |
| ATLOX 4913 (Acrylic copolymer solution) | 30 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.10 |
| Silcolapse 432 (non-ionic, polydimethylsiloxanic oil | 5 |
| based, aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Atplus 245 (Alcohols, C11-15-secondary, ethoxylated) | 40 |
| Xanthan Gum | 2 |
| water | Up to 1000 L |

### Preparation Procedure:

All the stages take place at room temperature about 23° C.±2° C.

### Stage 1—

5. Spirotetramat, ATLOX 4913, Break Thru 233, EthylanNS 500 LQ, proxel GXL, Silcolapse 432 (half the amount), propylene glycol and water (100 g/L) were mixed.
6. The mixture was milled to get the desired Particle size distribution LT 6 microns

### Stage 2—

5. ISOPAR v, EMCOL 4500 and Atplus 245 were mixed until clear solution was obtained.
6. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 4—Efficacy of Spirotetramat Formulations on Aphis gossypii

### Objective

To determine the efficacy of five (5) spirotetramat formulations, evaluated alongside Movento (commercial standard) against aphids, Aphis gossypii in terms of population mortality, following exposure to treated cucumber detach leaf.

### Methodology

Aphids, Aphis gossypii, were obtained from a laboratory culture maintained at the biokinetic lab.

Prior to the start of the experimental phase, the culture was maintained on cucumber (Cucumis sativus). For the bioassay, 1^{st} and 2^{nd} instar nymphs were selected.

Formulations 1-3 were evaluated alongside Movento 100SC (commercial format) and a water control. The water control treatment was included as a comparative measure to assess the batch fitness/survival of insects and to observe natural population dynamics under imposed trial conditions. All spirotetramat formulations were tested at the rate of 30 ppm.

Treatments were applied as a foliar application by pipetting 20 drops of 5 μL (microliter) directly onto the 1^{st} true cucumber leaf in every plant (BBCH 13), using a 2-20 μL Eppendorf pipettor. Following treatment application, plants were returned to the growth room and used in the bioassays after three days (i.e. after the plants had completely dried). Room temperature was 22° C. to 24° C. and Photoperiod of 16 h light/8 h dark. Relative humidity is approx. 35%.

Cucumber plants were grown from seed under laboratory conditions to BBCH stage 13 within a 7 cm diameter plastic plant pot filled with enriched compost. Several cucumber plant pots were prepared in advance of the trial. Test treatments were delivered as foliar applications by pipetting as described above.

Following a 3-day period to allow for drying and absorption, the infestation of the 3^{rd} true leaf took place. Well infested cucumber leaf from the Aphids lab colony was remove and cut to lcmXlcm fragments according to the number of plots in the trial. Each fragment was examined under the binocular to confirm a sufficient number of aphids are placed on it. The infested leaf fragment was then placed on top of the 3^{rd} true leaf in every treated plot. A period of 24 hours was given to the insects on the leaf fragments to self-transfer to the treated plant.

At the end of the 24-hour transfer period, the infested 3^{rd} true leaves were cut from the plant and placed under the binocular to evaluate the number of live 1^{st}-2^{nd} instar nymphs at the beginning of the trial. Once the live insect number was evaluated and listed, the treated leaves placed inside a 90 mm petri dish. To keep the petri dish moisten during the trial, 3 filter paper (Whatman grade 1 diameter 85 mm) were placed in each petri dish and 2 mL of sterilized distill water was pipette on the filter papers. The petri dishes then sealed with parafilm and placed in the insect room (temperature of 24° C. to 26° C. and photoperiod of 16 h light/8 h dark) for another 48 hours. Total time of the aphids on the treated leaves is approximately 72 hours.

Following the 72 hours period where the aphids fed from the treated leaves, the petri dished were unsealed and the number of dead aphids was evaluated under the binocular.

Mortality rate was then calculated as

$$\frac{number of dead aphids at the end}{number of live aphids at the start} * 100 ,$$

for every replica individually. Mortality rate for a single treatment is the average mortalities of the 3 replicates in the treatment.
Replication—3 replicates for every treatment, number of nymphs in every replicate varies from 20 to 60.

TABLE 4

| | | Ai | Applied | Applied | Mortality |
|---|---|---|---|---|---|
| Treatment | | concentration | vol | conc. | rate after |
| number | Treatment name | (ppm) | (μL) | (g Ai/L) | 72 hr |
| 1 | Movento 100SC | 30 | 100 | 0.03 | 34.03 |
| 2 | Formulation A | 30 | 100 | 0.03 | 50.27 |
| 3 | Formulation B | 30 | 100 | 0.03 | 39.58 |
| 4 | Formulation C | 30 | 100 | 0.03 | 42.54 |
| 5 | UTC | 30 | 100 | 0.00 | 15.92 |

### Conclusions—

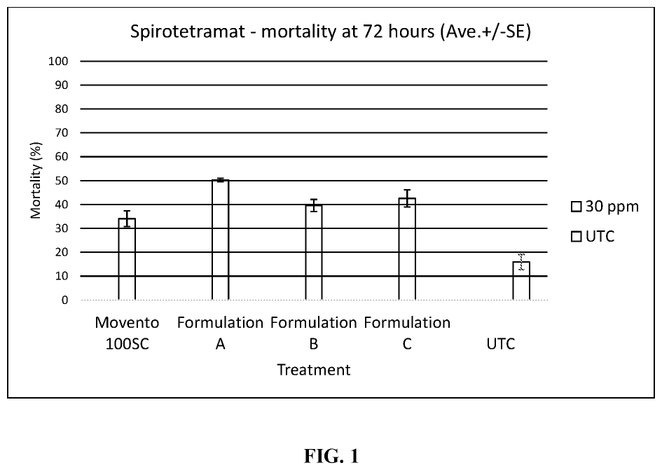

Movento® 100 SC is a suspension concentrate formulation sold by Bayer (active ingredient: spirotetramat at a concentration of 100 g/l).
The results in Table 4, and FIG. 1, clearly show that the formulations of the present invention (formulations A-C, see tables 1-3) are much more potent and effective against Aphids, than commercial formulation that exist in the market.

### Example 5—Spirotetramat Formulation D

TABLE 5

| Materials | g/L |
|---|---|
| Spirotetramat tech | 480 |
| AG-RH 23 (Xanthan Gum) | 2 |
| ATLOX 4913 (Acrylic copolymer solution) | 30 |
| Berol 535 (C11 Alcohol ethoxylate) | 20 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.20 |
| Silcolapse 432 (non-ionic, polydimethylsiloxanic | 10 |
| oil based, aqueous emulsion) | |
| Propylene Glycol | 50 |
| ISOPAR v (Mineral Oil 14-19) | 30 |
| EMCOL 4500 (Sodium dioctyl sulphosuccinate) | 20 |
| Alkamuls AP (PEG Ester/Ethoxylated Acid) | 40 |
| water | Up to 1000 L |

### Preparation Procedure:

All the stages take place at room temperature about 23° C.±2° C.

### Stage 1—

1. Spirotetramat, ATLOX 4913, Break Thru 233, EthylanNS 500 LQ, proxel GXL, Silcolapse 432 (half the amount), propylene glycol and water (100 g/L) were mixed.
2. The mixture was milled to get the desired particle size distribution LT 6 microns

### Stage 2—

7. ISOPAR v, EMCOL 4500 Berol 535 and Alkamuls AP were mixed until clear solution was obtained.
8. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 6—Spirotetramat Formulation E

TABLE 6

| Materials | g/L |
|---|---|
| Spirotetramat tech | 480 |
| AG-RH 23 (Xanthan Gum) | 2 |
| ATLOX 4913 (Acrylic copolymer solution) | 30 |
| Berol 535 (C11 Alcohol ethoxylate) | 20 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.20 |
| Silcolapse 432 (non-ionic, polydimethylsiloxanic | 10 |
| oil based, aqueous emulsion) | |
| Propylene Glycol | 50 |
| ISOPAR v (Mineral Oil 14-19) | 30 |
| EMCOL 4500 (Sodium dioctyl sulphosuccinate) | 20 |
| Atplus 245 LQ-(TH) (Alkoxylated Alcohol) | 40 |
| water | Up to 1000 L |

### Preparation Procedure:

All the stages take place at room temperature about 23° C.±2° C.

### Stage 1—

1. Spirotetramat, ATLOX 4913, Break Thru 233, EthylanNS 500 LQ, proxel GXL, Silcolapse 432 (half the amount), propylene glycol and water (100 g/L) were mixed.
2. The mixture was milled to get the desired particle size distribution LT 6 microns

### Stage 2—

1. ISOPAR v, EMCOL 4500, Berol 535 and Atplus 245 were mixed until clear solution was obtained.
2. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 7—Spirotetramat Formulation F

TABLE 7

| Materials | g/L |
|---|---|
| Spirotetramat tech | 480 |
| AG-RH 23 (Xanthan Gum) | 2 |
| ATLOX 4913 (Acrylic copolymer solution) | 30 |
| Berol 535 (C11 Alcohol ethoxylate) | 20 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.20 |
| Silcolapse 432 (non-ionic, polydimethylsiloxanic | 10 |
| oil based, aqueous emulsion) | |
| Propylene Glycol | 50 |
| ISOPAR v (Mineral Oil 14-19) | 30 |
| EMCOL 4500 (Sodium dioctyl sulphosuccinate) | 20 |
| Genapol X050 (Ethoxylated Isotridecyl Alcohol) | 40 |
| water | Up to 1000 L |

### Preparation Procedure

All the stages take place at room temperature about 23° C.±2° C.

### Stage 1—

1. Spirotetramat, ATLOX 4913, Break Thru 233, EthylanNS 500 LQ, proxel GXL, Silcolapse 432 (half the amount), propylene glycol and water (100 g/L) were mixed.
2. The mixture was milled to get the desired particle size distribution LT 6 microns

### Stage 2—

3. ISOPAR v, EMCOL 4500, Berol 535 and Genapol X050 were mixed until clear solution was obtained.
4. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 8—Spirotetramat Formulation G

TABLE 8

| Materials | g/L |
|---|---|
| Spirotetramat tech | 480 |
| Xanthan Gum | 2 |
| ATLOX 4913 (Acrylic copolymer solution) | 30 |
| Berol 535 | 40 |
| Break Thru 233 (non-ionic trisiloxane surfactant) | 10 |
| Ethylan NS 500 LQ (non-ionic surfactant, | 20 |
| polyalkoxylated butyl ether) | |
| proxel GXL (1,2-Benzisothiazolin-3-one) | 0.20 |
| Silcolapse 432 (non-ionic, polydimethylsiloxanic | 10 |
| oil based, aqueous emulsion) | |
| Propylene Glycol | 50 |
| ISOPAR v (Mineral Oil 14-19) | 20 |
| Emcol 4500 (Sodium dioctyl sulphosuccinate) | 20 |
| Methyl soyate (Soybean oil, methyl esters) | 20 |
| water | Up to 1000 L |

### Preparation Procedure:

All the stages take place at room temperature about 23° C.±2° C.

### Stage 1—

3. Spirotetramat, ATLOX 4913, Break Thru 233, EthylanNS 500 LQ, proxel GXL, Silcolapse 432 (half the amount), propylene glycol and water (100 g/L) were mixed.
4. The mixture was milled to get the desired particle size distribution LT 6 microns

### Stage 2—

5. ISOPAR v, EMCOL 4500, Berol 535 and Methyl Soyate were mixed until clear solution was obtained.
6. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 9—Efficacy for Control of Nymphs and Adults Mealvbugs (Planococcus ficus)

One field trail was conducted each trail was designed as a randomized block trail containing 6 treatments and four replications (total 24 plots per trail). 10 plants were evaluated in each plot, all the plants in each replicate were treated with each of the tested formulations.

The prototypes and the commercial products were applied via foliar application on Vitis vinifera ‘Colombard’ plants by using backpack sprayer pressurized with CO₂ was used for the formulation application, providing a volume of 100 L. dunam

The treatments were applied during the growing season of the mealybugs (Avg. Temperature of 25-27° C. Relative Humidity of 60-80%), following foliar pest infestation level of average of ˜2-5 adults mealybugs.

The pest evaluation was conducted 21 days after the application (DAA) on the nymphs & adult stage by counting the mealybugs on the wood and on the clusters. The number of alive adults was documented.

The values in Table 9 represents the efficacy of each treatment versus the untreated control.

TABLE 9

| | | Applied | % infected bunch |
|---|---|---|---|
| Treatment | | conc. | with mealybugs |
| number | Treatment name | (g Ai/L) | after 21 days |
| 1 | Formulation F | 96 | 5.6 |
| 2 | Formulation D | 96 | 5.0 |
| 3 | Formulation E | 96 | 1.3 |
| 4 | Formulation G | 96 | 6.3 |
| 5 | Movento HL + | 96 | 6.3 |
| | adjuvant (tank-mix) | | |
| 6 | UTC | — | 12.5 |

### Conclusions—

The tested build in adjuvants formulations (F-G) were as good as or better then Movento HL+external adjuvant (added as a recommendation on the product label).

### Example 10—Efficacy of spirotetramat formulations on Plutella xylostella Objective

Comparison of the efficacy of prototype c and Movento HL against Plutella xylostella in Brassica olerac.

### Methods:

A small plot trial was located at Nobby, QLD in 2021 to evaluate the bioequivalence of spirotetramat 480 SC prototype when compared to the commercial product Movento on Diamondback Moth (Plutella xylostella) in brassicas.

The trial was established in a commercial Warrior Cabbage crop (Brassica oleracea var. capitata cv. Warrior) within a localised area known to have Diamondback moth (DBM) pressure. Pre-application counts showed a moderate population averaging 2.0 larvae per plant with a majority of instar 2 and 3 sizing's. A total of three applications were carried out with the first application applied on the 3 October at a growth stage of BBCH 19-41, with subsequent applications applied at 8-day intervals.

DBM ins4 stage were assessed at 15 days after application A (DA-A).

TABLE 10

| | | | % Control | |
|---|---|---|---|---|
| | | Applied conc. | after | |
| No. | Treatment Name | (g Ai/L) | 15 days | |
| 1 | Untreated | | 0 | c |
| 2 | Movento HL 480 SC + Hasten | 48 + 704 | 21.6 | bc |
| 3 | Formulation C + Hasten | 48 + 704 | 72.4 | a |
| 4 | Movento HL 480 SC | 96 | 37.1 | abc |
| 5 | Formulation C | 96 | 53.9 | ab |

### Conclusions—

It is clear that formulation C is better than Movento HL 480 SC with and without the addition of Hasten (external adjuvant that was added due to the recommendation on the product label).

### Example 11—Control of Nymphs of Planococcus Spp.

### Objective:

Efficacy test of Movento 480 HL and ADAMA'S prototype C containing spirotetramat to control Planococcus spp nymphs

### Methods:

The biological efficacy of prototype C of Spirotetramat 480 SC with doses of 0.20 L/ha on white mealybugs Planococcus spp. in grapevine cultivation, and comparing them with commercial formulations of Movento 480 SC at a dose of 0.20, in addition to a control without application.

TABLE 11

| | | | Concentration | Dose | Dose |
|---|---|---|---|---|---|
| No. | Treatment | Active (IA) | (g IA/L o kg) | (g IA/Ha) | (mL o g/ha) |
| 1 | UTC | — | — | — | — |
| 2 | Movento HL 480SC | Spirotetramat | 480 | 96 | 200 |
| 3 | Formulation C | Spirotetramat | 480 | 96 | 200 |

The prototypes and the commercial products were applied via foliar application on Vitis vinifera plants by using backpack sprayer pressurized with CO₂ was used for the formulation application, providing a volume of 1,200 L/ha. The initial average infestation of the pest before spraying application was between 5-7 nymphs per treatment.

The trail had a completely randomized design.

The pest evaluation was conducted 3,7,10,14,28 days after the application (DAA) on the nymphs stage by counting the mealybugs on the wood and on the clusters.

TABLE 12

| No. | Treatment | DDA_3 | | DDA_7 | | DDA_10 | | DDA_14 | | DDA_28 | |
|---|---|---|---|---|---|---|---|---|---|---|---|
| 1 | UTC | 7 | a | 6.5 | a | 6.75 | a | 6 | a | 7.25 | a |
| 2 | Movento HL | 1.75 | a | 1.5 | a | 1.5 | a | 2 | a | 2.75 | b |
| | 480SC | | | | | | | | | | |
| 3 | Formulation C | 0 | b | 0 | b | 0 | b | 0.5 | b | 1.75 | b |

Table 12 represents the average results of Spirotetramat treatments in the number of nymphs of Planococcus spp. in the grape plants (5 plants per replica)

### Conclusions—

Formulation C shows significantly better efficacy vs. the commercial product and the untreated control.

In addition, any priority document(s) of this application is/are hereby incorporated herein by reference in its/their entirety.

1-58. (canceled)

59. A composition comprising a dispersion of solid particles of spirotetramat, an emulsification system, at least one adjuvant and an agriculturally acceptable carrier wherein the emulsification system comprises an oil phase and an emulsifier.

60. The composition according to claim 59, wherein the solubility of the spirotetramat in the oil phase is not more than 0.1% by weight based on the total amount of the spirotetramat.

61. The composition according to claim 59, wherein the oil phase is selected from mineral oil, canola oil and any combination thereof.

62. The composition according to claim 59, wherein: (a) the emulsifier is selected from dioctyl sodium sulfosuccinate, polyoxyethylene alkyl ether phosphates and any combination thereof; and/or (b) the ratio between the oil phase and the emulsifier is of about 1:0.3 to about 1:1; and/or (c) the at least one adjuvant is soluble in the emulsification system.

63. The composition according to claim 59, wherein: (a) the at least one adjuvant is selected from alkyl ester of fatty acids, alcohol alkoxylates and any combination thereof, preferably wherein: the alkyl ester of fatty acids is methyl ester of fatty acids; and/or the alcohol alkoxylates are compounds having the formula: R1-O—(CmH2mO)x-(CnH2nO)y-H
wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50; and/or (b) the amount of the at least one adjuvant in the composition is of about 1% to of about 5% by weight, based on the total weight of the composition and/or (c) the amount of spirotetramat is of about 10% to of about 60% by weight, based on the total weight of the composition.

64. The composition according to claim 59, wherein the agriculturally acceptable carrier is liquid or solid, preferably wherein: the liquid carrier is water and the solid carrier is selected from calcium carbonate, kaolin, talc, corn starch lactose and any combination thereof

65. A method for controlling animal pests comprising applying an effective amount of the composition according to claim 59, to a locus where the animal pest is to be controlled and/or prevented so as to thereby control and/or prevent the animal pest.

66. The method according to claim 65, wherein: (a) the locus is a crop field preferably wherein the crop is selected from the group consisting of pomaceous fruit, stone fruit, soft fruit, apples, pears, avocado, plums, peaches, almonds, cherries, berries, strawberries, raspberries, blackberries, citrus fruit, oranges, lemons, grapefruit, tangerines, cucurbits, pumpkins, cucumbers, melons, lettuce, cabbages, carrots, tomatoes, potatoes, peppers, chili, okra, eggplants; beans, peas, soya, oilseed rape, olives, sunflowers, ground nuts, cotton, nuts, coffee, grapevines, ornamentals, lauraceae; and/or (b) the animal pest is selected from the order of Lepidoptera, Diptera, Hemiptera, Thysanoptera, Coleoptera, Hymenoptera Heteroptera, Homoptera, Thysanoptera, acarine, nematode and mollusc; and/or (c) the composition is applied in an amount from about 0.03 L/ha to of about 0.6 L/ha; and/or (d) the composition is applied in an amount from about 18 g/ha of spirotetramat to about 288 g/ha of spirotetramat.

67. A method for preparing a stable built-in adjuvant compatible composition characterized in the addition of an emulsification system and at least one adjuvant to a dispersion of solid particles of spirotetramat in an agriculturally acceptable carrier, wherein the emulsification system comprises an oil phase and an emulsifier.

68. The method according to claim 67, wherein: (a) the oil phase is selected from mineral oil, canola oil and any combination thereof and/or (b) the emulsifier is selected from dioctyl sodium sulfosuccinate, polyoxyethylene alkyl ether phosphates and any combination thereof and/or (c) the ratio between the oil phase and the emulsifier is of about 1:0.3 to about 1:1; and/or (d) the at least one adjuvant is soluble in the emulsification system.

69. The method according to claim 67, wherein the at least one adjuvant is selected from optionally alkyl ester of fatty acids, alcohol alkoxylates and any combination thereof preferably wherein: the alkyl ester of fatty acids is methyl ester of fatty acids and/or the alcohol alkoxylates are compounds having the formula: R1-O—(CmH2mO)x-(CnH2nO)y-H
wherein R1 is linear or branched, saturated or unsaturated alkyl radical having from 7 to 20 carbon atoms; or R1 is linear or branched, saturated or unsaturated acyl radical having from 14 to 20 carbon atoms; or R1 is phenyl which is optionally mono to tri substituted by alkyl group; or any combination thereof, m is an integer equal to 2, n is an integer equal to 3, x is an integer of from 1 to 50 and y is an integer of from 0 to 50.

70. The method according to claim 67, wherein: (a) the amount of the at least one adjuvant in the composition is of about 1% to of about 5% by weight, based on the total weight of the composition and/or (b) the amount of spirotetramat is of about 10% to of about 60% by weight, based on the total weight of the composition.

71. The method according to claim 67, wherein the agriculturally acceptable carrier is liquid or solid preferably wherein: the liquid carrier is water, and the solid carrier is selected from calcium carbonate, kaolin, talc, corn starch lactose and any combination thereof.
